(19) United States
(12) Patent Application Publication
(10) Pub. No.: US 2026/0244666 A1
(43) Pub. Date: Aug. 20, 2026

(54) Systems and Methods for Use of Artificial Intelligence in Remote Networked Submissions

(71) Applicant: EEO Solutions LLC, Winnabow, NC (US)

(72) Inventor: Jonathan Hunter Lama, Winnabow, NC (US)

(21) Appl. No.: 19/334,249

(22) Filed: Sep. 19, 2025

Related U.S. Application Data
(60) Provisional application No. 63/759,175, filed on Feb. 16, 2025.

(51) Int. Cl. G06F 16/334

(52) U.S. Cl. CPC G06F 16/3344

(57) ABSTRACT

Exemplary embodiments include a method for preparing documents using artificial intelligence, executable by a processor coupled to a database, a large language model (LLM), and a memory storing instructions for the method. The method comprises: receiving a data input relating to a document submission; parsing the input by natural language processing; transmitting a sequence of requests for further input, the sequence being determined by the LLM applying a decision tree; retrieving a template from a library stored in the database, the template being identified from a signal activated by an activation element; and merging the parsed data into the template. The merging may comprise receiving the parsed data as a first aspect of a prompt; receiving from the at least one database a parameter as a second aspect of the prompt; generating a response to the prompt by the LLM; and generating a document with the response.

### CROSS-REFERENCE TO RELATED APPLICATIONS

The present application claims the priority benefit of U.S. Provisional Patent Application Serial No. 63/759,175, filed on February 16, 2025, titled “EEO Solutions (A -Driven EEO Complaint Processing System”, which is hereby incorporated by reference in their entirety, including all appendices.

### FIELD OF THE TECHNOLOGY

Embodiments of the disclosure relate to artificial intelligence systems and their applications for document generation from received data inputs and pre-defined parameters. In particular, but not by way of limitation, these systems relate to document generation by merging received data inputs with generative templates for submission with one or more agency or organization.

### SUMMARY OF EXEMPLARY EMBODIMENTS

Embodiments of the disclosure include a method for preparing one or more documents for a networked submission using artificial intelligence, executable by at least one processor communicatively coupled to at least one database, at least one large language model, and a memory storing instructions which, when executed, cause the processor to execute the steps of the method, the method comprising: receiving, by a user interface having at least one activation element, an initial data input from a user during a user session, the initial data input relating to a document submission for at least one organization; parsing the data input by natural language processing; transmitting a sequence of one or more data requests for a further data input to the user interface, the sequence of one or more data requests being determined by the large language model applying a decision tree model to the parsed data; identifying and retrieving at least one template from a template library stored in the at least one database, the at least one template being identified from a signal activated by the at least one activation element; and merging the parsed data into the at least one template. The merging generally comprises receiving the parsed data as a first aspect of a prompt for the large language model; receiving from the at least one database at least one parameter as a second aspect of a prompt for the large language model; generating at least one response to the prompt by the large language model; and generating an electronic document with the at least one response.

In some embodiments, the method further comprises supporting a conversational AI interface by the at least one large language model, the conversational AI interface being trained using the user input, historical data, and feedback.

The at least one parameter may be determined from compliance data, the compliance data being stored in the at least one database and identified by the signal activated by the at least one activation element.

The system may issue real time alerts by an alert notification module, the real time alerts indicating noncompliance with one or more compliance standards associated with the at least one parameter.

Some embodiments further include data validation and error checking of the initial data input and the further data inputs for errors, omissions, and consistency.

Methods and systems include Application Programming Interfaces (APIs) or plugins for integration with third party platforms.

The system may also generate one or more educational components in the user interface, the one or more educational components having learning pathways that are personalized for the user based at least on the initial data input and the further data inputs.

The user interface may further comprise one or more accessibility features, the one or more accessibility features comprising any one of: alternative text, eye tracking, keyboard navigation support, voice command input, and screen reading.

The system may support one or more input access points connected by a networked, multiple user platform.

In addition to these exemplary systems and methods, this disclosure includes non-transitory computer-readable storage media having embodied thereon instructions for the methods executable by these systems.

In further exemplary embodiments, the system may be an intelligent secure networked messaging system configured by at least one processor to execute instructions stored in memory, including a data retention system and an analytics system, the analytics system performing asynchronous processing with a computing device and the analytics system communicatively coupled to a deep neural network, the deep neural network configured to receive a first input at an input layer, process the first input by one or more hidden layers, generate a first output and transmit the first output to an output layer, which may generate a first outcome. The first outcome may be transmitted to the input layer as input, and the first input may be a first set of compliance data. Additionally, the first output may be a predictor of a regulatory compliance issue and/or the first outcome may be an expected or anticipatory set of compliance data.

### BRIEF DESCRIPTION OF THE DRAWINGS

While this technology is susceptible of embodiment in many different forms, there is illustrated in the drawings, and will herein be described in detail, several specific embodiments with the understanding that the present disclosure is to be considered as an exemplification of the principles of the technology and is not intended to limit the technology to the embodiments illustrated.

It will be understood that like or analogous elements and/or components, referred to herein, may be identified throughout the drawings with like reference characters. It is further understood that several of the figures are merely schematic representations of the present technology. As such, some of the components may be distorted from their actual scale for pictorial clarity.

FIG. 1 diagrammatically illustrates an exemplary system of the present disclosure.

FIG. 2 diagrammatically illustrates an exemplary AI-driven intake module.

FIG. 3 diagrammatically illustrates an exemplary compliance engine.

FIG. 4 diagrammatically illustrates an exemplary document generation module.

FIG. 5 diagrammatically illustrates an exemplary educational component.

FIG. 6 diagrammatically illustrates an exemplary conversational AI interface.

FIG. 7 diagrammatically illustrates an exemplary deep neural network.

### DETAILED DESCRIPTION OF EXEMPLARY EMBODIMENTS

Embodiments of the present disclosure utilize artificial intelligence technologies, including Large Language Models, or LLMs.

As used herein, the term language model generally refers to a probability distribution over sequences of words. Language models generate probabilities by training on large and structured sets of text, or text corpora. A single text corpus may include a single language or many languages, and may have various levels of structure based on, for example, grammar, syntax, morphology, semantics, and pragmatics.

A Large Language Model, or LLM, refers to a language model consisting of a deep learning architecture that is trained on large quantities, often tens of gigabytes, of unlabeled text using self-supervised learning or semi-supervised learning to produce generalizable and adaptable output. The deep learning architecture may be comprised of a neural network with billions of weights or parameters. In some embodiments, the neural network may be a transformer, which uses parallel multi-head attention mechanism, or alternatively the neural network may be recursive, operating in sequence.

Additionally, in some embodiments, the Large Language Model is communicatively coupled with one or more source databases.

Various embodiments of the present disclosure include systems and methods for use of artificial intelligence in networked submission processing. Exemplary embodiments are directed to submissions of requests, complaints, reports, and other documents to government agencies. Examples below are primarily directed to complaints submitted to the Equal Employment Opportunity Commission (EEOC). However, the systems and methods described herein are not limited EEOC submissions or to submission with government agencies generally.

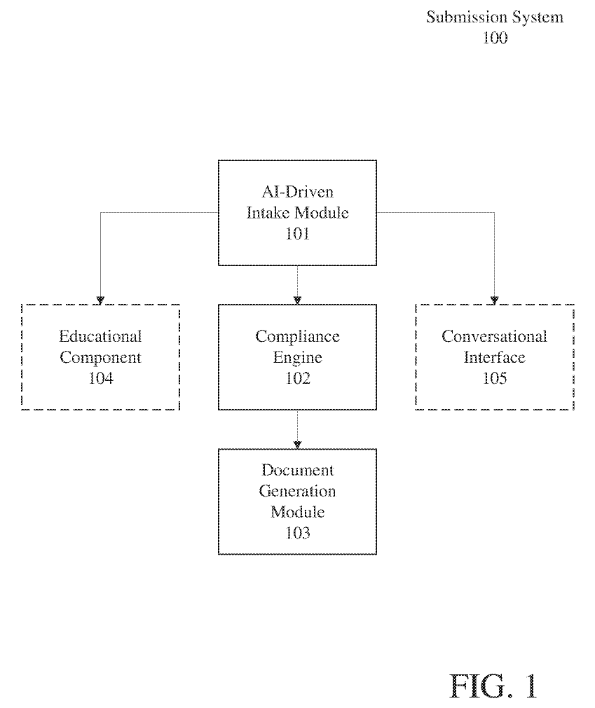

FIG. 1 diagrammatically illustrates an exemplary system of the present disclosure. Exemplary embodiments include a submission system 100 having an AI-Driven Intake Model 101, a Compliance Engine 102, and a Document Generation Module 103. In some embodiments, an Educational Component 104 and a Conversational AI Interface 105 are also included. The purposes, functions, and methods of use for each component will be discussed below.

According to an exemplary method, an AI-Driven Intake Model 101 guides a user through a process of submitting an Equal Employment Opportunity (EEO) complaint, dynamically adjusting questions based on user responses to ensure completeness and accuracy.

A Compliance Engine 102 ensures all collected information and completed documents adhere to federal guidelines, such as EEOC management directives and the Code of Federal Regulations.

A Document Generation Module 103 automates the creation of accurate and compliant EEOC complaint documentation by merging generated response text with pre-defined templates or, in some embodiments, with generative templates.

An Educational Component 104 provides real-time information to users about their rights and available options during the complaint process, helping to reduce non-EEOC-related complaints.

A Conversational AI Interface 105 interacts with users through a chat box or human voice, enhancing user experience and accessibility. The AI interface adapts to user responses for a guided, intuitive experience.

In various embodiments, multiple platform accessibility enables users to access the software via desktop applications, SharePoint, or cloud-based systems, ensuring widespread availability. Accessibility features accommodate users with disabilities, including compatibility with assistive technologies, screen readers, voice input, and adjustable text size.

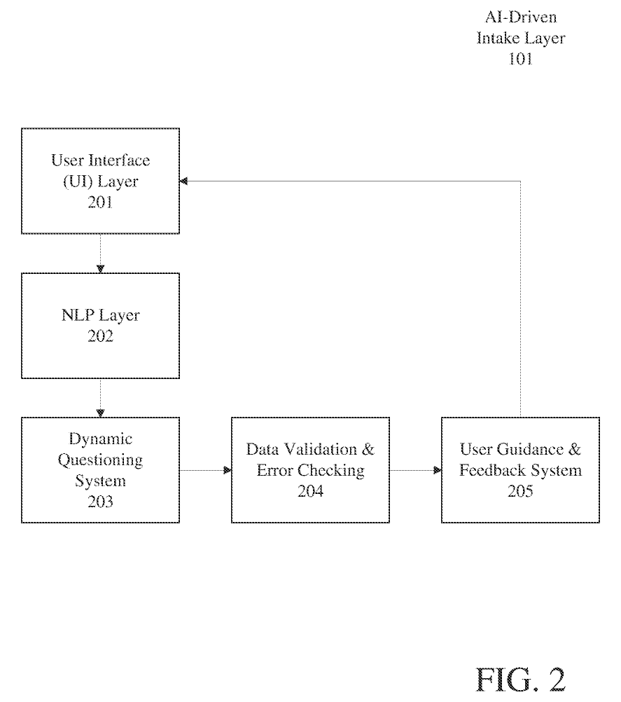

FIG. 2 diagrammatically illustrates an exemplary AI-Driven Intake Module 101. In various embodiments, the AI-Driven Intake Module 101 is a software component supported by artificial intelligence and integrated into an application. The AI-Driven Intake Module 101 comprises a plurality of sub-components, including a User Interface (UI) layer 201; a Natural Language Processing (NLP) Engine 202; a Dynamic Questioning System 203; Data Validation and Error Checking 204; and a User Guidance and Feedback System 205.

The UI Layer 201 comprises a front-end interface through which a user interacts with the system. The UI Layer 201 includes text fields, drop-down menus, and other input controls that guide the user through the submission process. In various embodiments, the UI Layer 201 is adaptable to match the design scheme and preferences of an organization, including layout and other design aspects, while maintaining core functionality.

The NLP Layer 202 comprises a back-end component that processes user input received in plain text or, in some embodiments, converted to plain text from an alternate format. An example of converted plain text includes user-submitted speech converted by speech-to-text. In various embodiments, the NLP Layer 202 comprises a large language model that is trained using natural language and terminology directly related to one or more specific agencies or parties, such as the EEOC and its applicable law and procedure. In some embodiments, one or more user submissions, either singly, in sequence, or otherwise in combination, are used as training inputs for the large language model.

In various embodiments, the NLP Layer 202 is modular, enabling organizations to elect a customized language model or AI provider based on their specific needs, such as models specifically trained on legal or EEO-related terminology.

The Dynamic Questioning System 203 comprises a logic-based system that adjusts the content and flow of questions, prompts, or other guided input requests presented to a user to ensure that all relevant information is gathered while minimizing redundant or irrelevant prompts. In various embodiments, the Dynamic Questioning System 203 is built on a decision tree model. The Dynamic Questioning System 203 customizes the intake process to suit the circumstances of each submission.

The Data Validation and Error Checking 204 module ensures that input data is complete, accurate, and within any required parameters before proceeding to the next step in the submission process.

The AI-Driven Intake Module 101 serves as the primary interaction point for user submissions. In an exemplary embodiment, the AI-Driven Intake Module 101 presents one or more questions regarding the nature of the submission. For an EEOC complaint, these questions would generally pertain to the nature of the complaint. The NLP Layer 202 interprets user input, whether typed or spoken. The submission is thus received in plain text.

As the user responds, the AI-Driven Intake Module 101 uses the Dynamic Questioning System 203 to adapt the flow of system questions, prompts, or other guided input requests to ensure that any and all necessary information is collected.

The Data Validation and Error Checking 204 module checks user input in real time, validating data and ensuring that all required fields are completed. If any data are missing, inconsistent, or actually or ostensibly erroneous, the Data Validation and Error Checking 204 prompts the user to correct the input before the system will proceed.

User Guidance and Feedback System 205 provides real-time assistance to users, offering tips, explanations, and feedback as the users progress through the intake process. In various embodiments, the User Guidance and Feedback System 205 comprises a large language model that generates the tips, explanations, and feedback in natural language in response to a user-submitted request for a tip, explanation, or feedback. For example, a user may click a link that says, “What does this mean?” or “Does this apply to me?”

In some embodiments, user guidance tips, explanations, and feedback do not require a user to click a specific link. The User Guidance and Feedback System 205 initiates tips, explanations, and feedback automatically as the user proceeds through the submission process.

The User Guidance and Feedback System 205 receives a prompt with the user-submitted click and generates a response based on the prompt, context, and content of the submission. In some embodiments, the User Guidance and Feedback System 205 uses any user-submitted text to train the large language model.

In various embodiments, the AI-Driven Intake Module 101 is equipped with additional accessibility features, including multilanguage support, enhanced voice command systems, or integration with assistive technologies like eye-tracking devices or switch controls.

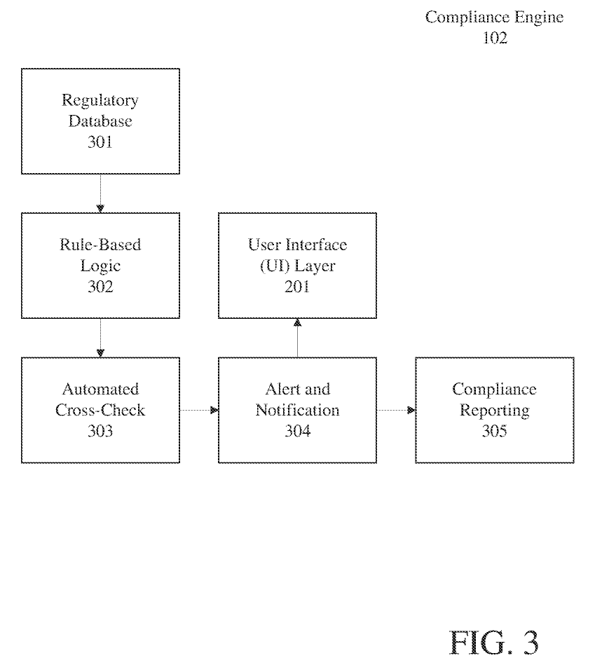

FIG. 3 diagrammatically illustrates an exemplary compliance engine. The Compliance Engine 102 ensures that all data collected during the submission process adheres to relevant guidelines. In various embodiments, the Compliance Engine 102 comprises: a Regulator Database 301; a Rule-Based Logic 302; an Automated Cross-Check System 303; and an Alert and Notification System 304. Some embodiments include a Compliance Reporting Tool 305 for generating detailed reports on compliance status.

The Regulatory Database 301 comprises a comprehensive database that houses relevant regulations. In EEO-related embodiments, these regulations include EEOC Management Directives, relevant chapters or sections of the Code of Federal Regulations, and other applicable guidelines. In various embodiments, the Regulatory Database 301 is regularly updated to reflect changes, such as newly issued regulations or caselaw. In some embodiments, the Regulatory Database 301 is expandable to include state or industry-specific regulations. In various embodiments, the Regulatory Database 301 comprises a plurality of databases, some of which may be general purpose or specific and purpose defined.

The Rule-Based Logic 302 comprises a set of one or more algorithms or rules designed to compare user-provided information against the requirements identified in the Regulatory Database 301. The Rule-Based Logic 302 is scalable in scope and, in some embodiments, is integrated with machine learning models for predictive compliance analysis. By incorporating predictive compliance analysis, agencies and organizations can anticipate potential compliance issues before they arise.

The Automated Cross-Check Mechanism 303 monitors and cross-checks the information received and processed by the AI-Driven Intake Module 101 against the requirements identified in the Regulatory Database 301. The Automated Cross-Check Mechanism 303 flags discrepancies, errors, or compliance issues.

The Alert and Notification System 304 is integrated into the UI Layer 201 and notifies users and administrators if any part of the submission or documentation fails to meet compliance standards. The notifications are generally issued in real time or near real time. In various embodiments, the Alert and Notification System 304 also provides guidance on how to correct the issues. Guidance is generally provided with the support of a large language model that generates a natural language response to a user-submitted request. For example, a user may click a link that says, “How can this be addressed?” or “What does this mean?”

The Alert and Notification System 304 receives a prompt with the user-submitted click and generates a response based on the prompt, context, and content of the submission. In some embodiments, the Alert and Notification System 304 uses any user-submitted text to train the large language model.

In some embodiments, the Alert and Notification System 304 is customized to provide a preferred level of notification based on the severity of a compliance issue. The administrator may escalate the preferred notification level if desired.

The Compliance Reporting Tool 305 generates detailed reports on the compliance status of individual companies or groups of complaints, providing insight into trends and potential risks. In various embodiments, the reports are customized with the support of a large language model that receives a prompt for a report based on the compliance issue, a party’s role in the organization, and a user’s role in an organization. Examples include requests for summary reports or, alternatively, detailed analyses.

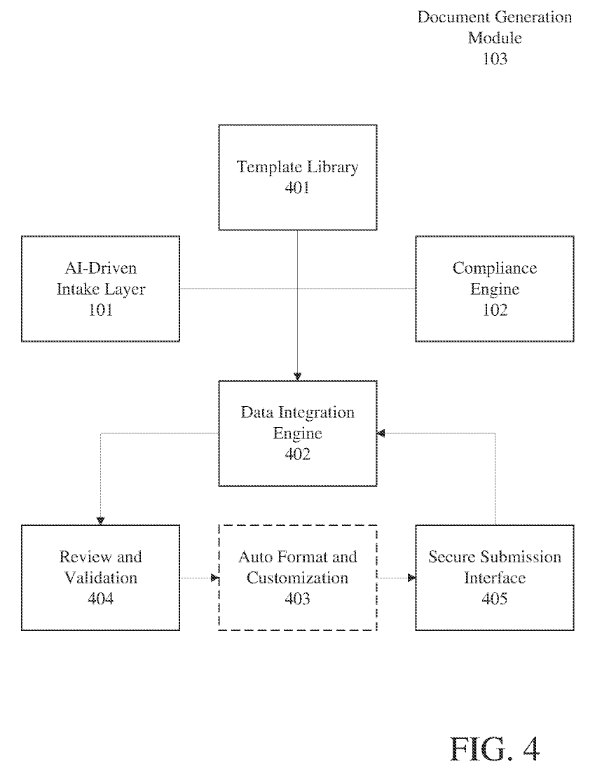

FIG. 4 diagrammatically illustrates an exemplary Document Generation Module 103. The Document Generation Module 103 creates necessary documentation related to the submission and comprises the following sub-components: Template Library 401, which in turn comprises a collection of pre-designed or AI-generated templates; Data Integration Engine 402, which pulls data collected during the intake process, as well as compliance checks, and merges the data into one or more templates; Automated Formatting and Customization Tool 403, which adjusts the document layout, format, and content based on specific case details and organizational parameters; and Review and Validation System 404, which reviews the content for completeness, accuracy, and compliance with relevant guidelines; and a Secure Submission Interface 405.

The Document Generation Module 103 receives the data collected by the AI-Driven Intake Module 101 and verified by the Compliance Engine 102 and automatically creates one or more relevant documents. In some embodiments, the Document Generation Module 103 uses pre-approved templates and a Data Integration Engine 402 to ensure that every document adheres to the necessary standards.

When a user initiates a session on the UI Layer 201, a signal is transmitted to the Document Generation Module 103 to select one or more templates for merger from the Template Library 401. For example, the user may initiate a session and indicate that the reason for the session is an employment retaliation complaint. The indication of the reason may be a link, selection from a menu, or, in some embodiments, submitted via plain text and parsed by natural language processing. The indicator acts as an activation element for a signal that is sent to the Document Generation Module 103, and a template for a retaliation complaint is selected for merger from the Template Library 401.

Parsed data as received from the AI-Driven Intake Layer 101 and checked against the Compliance Engine 102 is then merged into the template. In various embodiments, the merger process comprises receiving the parsed data as part of a prompt for a large language model; receiving at least one parameter as a part of the prompt for the large language model; generating a response by the large language model; and generating the document with the response. Parameters may be determined from compliance data as maintained by the Compliance Engine 102.

In some embodiments, Review and Validation System 404 queues documents for human review, either by default or upon a condition such as a detected discrepancy.

A Secure Submission Interface 405 transmits the submitted document to the relevant organization or authority. In various embodiments, the secure submission comprises encryption and secure channels for sensitive information.

In some embodiments, multiple users access an editable document by way of a networked, multi-user platform. Users are enabled by the platform to collaborate on one or more documents in real time, with version control and change tracking. In some embodiments, documents are automatically archived and/or stored securely in a centralized repository, with tagging and search capabilities for easy retrieval.

The system may also use the Large Language Model to generate affidavits. The system applies the Dynamic Questioning System 203 and, in some embodiments, pulls questions from a question bank. The question bank is generally tied to claim types or events. The Dynamic Questioning System 203 receives the user input. Following the procedures outlined herein, the system generates affidavits by the Document Generation Module 103, including by merging document templates from the Template Library 401 with one or more output responses from the LLM. In various embodiments, the affidavit includes metadata and e-signatures as submitted by users or administrators. The affidavit may also include tamper-proof storage protocols to maintain a valid record.

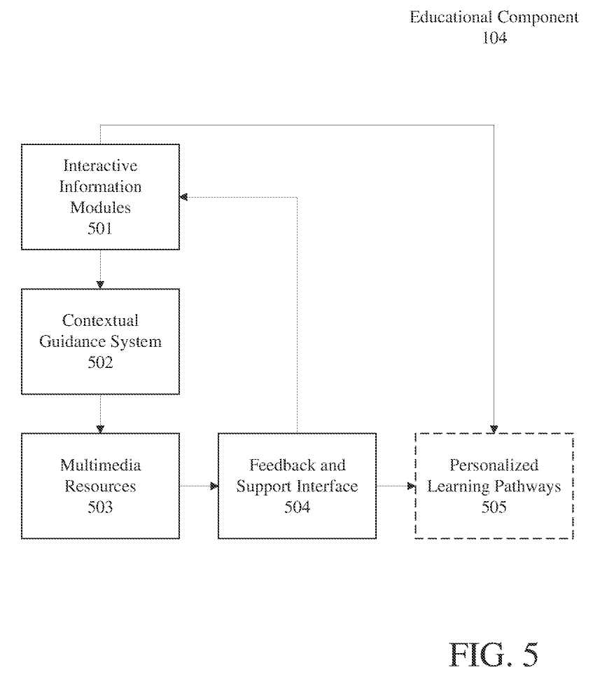

FIG. 5 diagrammatically illustrates an exemplary Educational Component 104. The Educational Component 104 is designed to provide users with real-time information, such as their rights and options, during a submission process.

The Educational Component 104 comprises: Interactive Information Modules 501, which, in various embodiments, are organized in categories and accessible by the UI Layer 201; Contextual Guidance System 502, which provides information dynamically based on the user’s inputs during the intake process; Multimedia Resources 503; and a Feedback and Support Interface 504, which in various embodiments comprises a support system that allows users to ask questions, seek clarification, and receive immediate answers based on the available educational content in the system. The Feedback and Support Interface 504 is generally supported by a purpose-specific large language model. In some embodiments, Personalized Learning Pathways 505 are included. These Personalized Learning Pathways 505 comprise tailored educational tracks that adapt to each user’s specific needs and knowledge level, ensuring relevant and efficient learning.

The Educational Component 104 educates users regarding the submission process and, if necessary, informs users of alternative options. This saves time and resources for both the user and organization and enhances user understanding. In various embodiments, the Educational Component 104 is integrated with external training or learning management systems, allowing organizations to track user progress and compliance training. Learning tracks may also be modified based on skill level or role. In various embodiments, the Educational Component 104 incorporates adaptive learning technology that adjusts the difficulty and focus of educational content based on user performance and engagement. The Educational Component 104 may also include a certification system for users who complete educational modules.

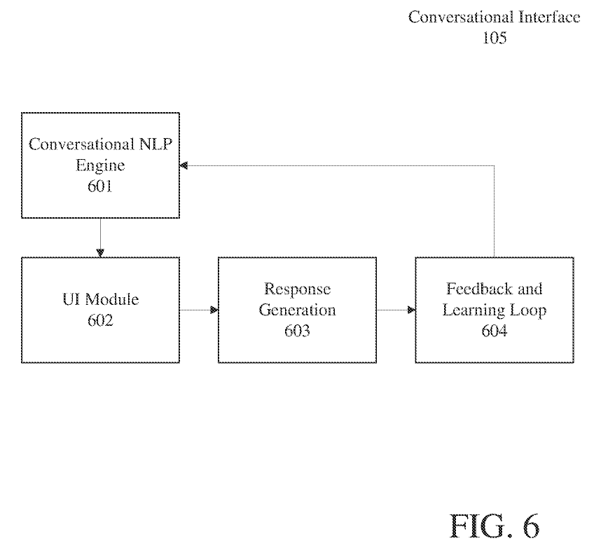

FIG. 6 diagrammatically illustrates an exemplary Conversational AI Interface 105. The Conversational AI Interface is designed to facilitate user interaction through text-based or voice-based communication.

The Conversational AI Interface 105 comprises a Conversational Natural Language Processing (NLP) Engine 601, which in various embodiments uses the NLP Layer 202 of the AI-Driven Intake Layer 101 or, alternatively, uses a separate subsystem with its own purpose-specific NLP layer; User Input (UI) Module 602, which in various embodiments uses the UI Layer 201 of the AI-Driven Intake Layer 101 or, alternatively, uses a separate subsystem with its own purpose-specific input layer; Response Generation System 603; and a Feedback and Learning Loop 604.

The Conversational NLP Engine 601 processes voice or text entries received via the UI Module 602. The Response Generation System 603 is supported by a large language model and generates a response based on the user-submitted prompt and any parameters set by an organization for automatic inclusion in the prompt. In some embodiments, the historical record of a conversation is used to contextually shape a response generated by the Response Generation System 603.

A Feedback and Learning Loop 604 continuously trains the artificial intelligence model based on training data, such as user submissions, historical and/or real time feedback, and other training data. In some embodiments, users create a unique profile with a login and unique profile identification data. The profile identification data and historical behavior on the platform may be used as historical or contextual data for training the model or generating new responses.

In various embodiments, the submission system 100 is integrated with external systems, including but not limited to external databases. These may include human resources (HR) or legal case-management software. This integration allows for automatic retrieval and population of relevant data. In some embodiments, the submission system 100 is integrated with real-time legal compliance monitoring systems.

Various embodiments of the present disclosure implement accessibility integration features, which includes functions for persons with one or more disabilities or accessibility concerns. Accessibility integration module includes features such as screen reader, voice command recognition, and options to adjust text size or switch to audio-only mode. Some embodiments code any of the interface layers with appropriate Accessible Rich Internet Applications (ARIA) labels, alternative text for images, eye-tracking, and keyboard navigation support. Some embodiments utilize voice commands as an alternative to traditional mouse and keyboard inputs. Text size, color, font, and contrast are adjustable for persons with vision impairment, including color blindness.

In various embodiments, the systems and methods described herein utilize multiple platform accessibility. Applications using these systems and methods are generally accessible across various platforms, including desktop applications, SharePoint, and cloud-based systems. The codebase is compatible with multiple operating systems, such as Windows and MacOS, as standalone desktop applications on local machines as well as in web browsers and cloud environments.

Features are included for offline access, such as data synchronization to the cloud once a connection is reestablished. In some embodiments, a unified data management system ensures that data is consistent and synchronized across a plurality of platforms.

With cloud and SharePoint integration, the application facilitates collaboration among users, allowing multiple stakeholders to access, review, and work on a submission simultaneously. The unified data management system ensures that all users see the most up-to-date information, reducing the risks of errors or duplication.

In some embodiments, the system uses one or more rules or criteria to determine whether a submission to the agency or organization is accepted. The one or more Large Language Models use Natural Language Processing to parse the submitted request and first determine whether the relevant body of regulations applies. For example, the LLM determines whether a complaint to the EEOC falls within the scope of an employment dispute or is completely unrelated. The LLM may draw on the relevant body of regulations from the Regulatory Database 301. The LLM subsequently generates a notice of acceptance or dismissal with the reasoning based on the relevant body of regulations. The notice may be generated by merging a plain text response with a notice template from the Template Library 401 by way of the Data Integration Engine 402.

The notice, in various embodiments, includes upcoming deadlines, information regarding appealing the decision, and a log of how the decision was made. In various embodiments, the notice is queued for human review. The human review may approve the notice or identify errors and re-train or fine-tune the LLM as needed.

Some embodiments further include a method and module for bias detection, whereby the system identifies patterns in acceptance or dismissal of user submissions, or in affidavits. In such embodiments, a prompt is submitted to an LLM to review a historic record of submissions received and identify whether a given user trait, or a given group of user traits, has a high correlation with acceptance or with rejection. In some responses, the response to this review request is compared with similar requests for other traits, other groups of traits, or against background data comprising all submissions of a given type or in a given time period.

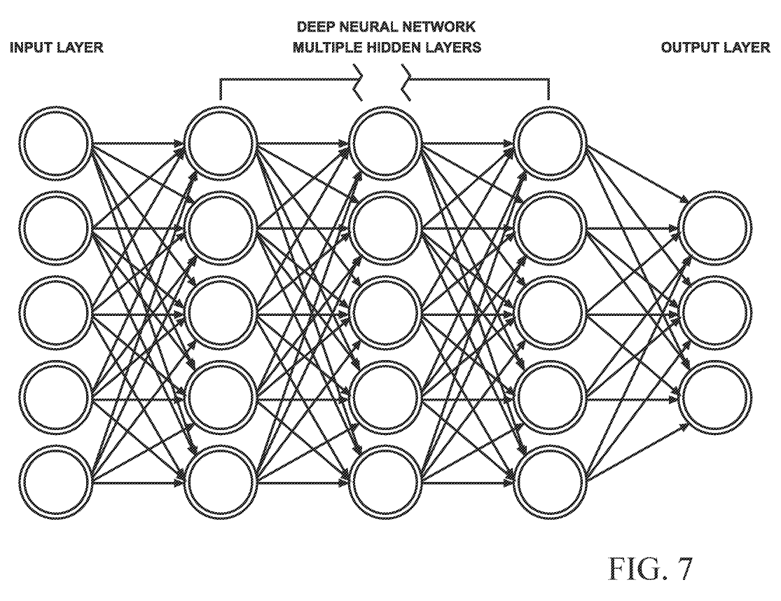

FIG. 7 shows an exemplary deep neural network.

Neural networks, also known as artificial neural networks (ANNs) or simulated neural networks (SNNs), are a subset of machine learning and are at the heart of deep learning algorithms. Their name and structure are inspired by the human brain, mimicking the way that biological neurons signal to one another. Artificial neural networks (ANNs) are comprised of node layers, comprising an input layer, one or more hidden layers, and an output layer. Each node, or artificial neuron, connects to another and has an associated weight and threshold. If the output of any individual node is above the specified threshold value, that node is activated, sending data to the next layer of the network. Otherwise, no data is passed along to the next layer of the network.

Neural networks rely on training data to learn and improve their accuracy over time. However, once these learning algorithms are fine-tuned for accuracy, they are powerful tools in computer science and artificial intelligence, allowing one to classify and cluster data at a high velocity. Tasks in speech recognition or image recognition can take minutes versus hours when compared to the manual identification by human experts.

In some exemplary embodiments, one should view each individual node as its own linear regression model, composed of input data, weights, a bias (or threshold), and an output. Once an input layer is determined, weights are assigned. These weights help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires”, or activates the node, passing data to the next layer in the network. This results in the output of one node becoming the input of the next node. This process of passing data from one layer to the next layer defines this neural network as a feedforward network. Larger weights signify that particular variables are of greater importance to the decision or outcome.

According to some exemplary embodiments, deep neural networks are feedforward, meaning they flow in one direction only, from input to output. However, one can also train a model through backpropagation; that is, move in the opposite direction from output to input. Backpropagation allows one to calculate and attribute the error associated with each neuron, allowing one to adjust and fit the parameters of the model(s) appropriately.

In machine learning, backpropagation is an algorithm for training feedforward neural networks. Generalizations of backpropagation exist for other artificial neural networks (ANNs), and for functions generally. These classes of algorithms are all referred to generically as "backpropagation". In fitting a neural network, backpropagation computes the gradient of the loss function with respect to the weights of the network for a single input–output example, and does so efficiently, unlike a naive direct computation of the gradient with respect to each weight individually. This efficiency makes it feasible to use gradient methods for training multilayer networks, updating weights to minimize loss; gradient descent, or variants such as stochastic gradient descent, are used. The backpropagation algorithm works by computing the gradient of the loss function with respect to each weight by the chain rule, computing the gradient one layer at a time, iterating backward from the last layer to avoid redundant calculations of intermediate terms in the chain rule; this is an example of dynamic programming. The term backpropagation strictly refers only to the algorithm for computing the gradient, not how the gradient is used; however, the term is often used loosely to refer to the entire learning algorithm, including how the gradient is used, such as by stochastic gradient descent. Backpropagation generalizes the gradient computation in the delta rule, which is the single-layer version of backpropagation, and is in turn generalized by automatic differentiation, where backpropagation is a special case of reverse accumulation (or "reverse mode").

With respect to FIG. 7, according to some exemplary embodiments, the system produces an output, which in turn produces an outcome, which in turn produces an input. In some embodiments, the output may become the input.

Deep Neural Networks, such as the one exemplified in FIG. 7, can be used to support artificial intelligence methods and systems, such as Large Language Models, for the embodiments described herein.

While various embodiments have been described above, it should be understood that the embodiments have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the technology as defined by the appended claims. Thus, the breadth and scope of a preferred embodiment should not be limited by any of the above-described exemplary embodiments.

What is claimed is:

1. A system for preparing one or more documents for a networked submission using artificial intelligence, the system comprising:
at least one large language model;
at least one database communicatively coupled with the at least one large language model; and
at least one processor communicatively coupled to the at least one database and the at least one large language model and further communicatively coupled to a memory storing instructions which, when executed, cause the processor to:
receive, by a user interface having at least one activation element, an initial data input from a user during a user session, the initial data input relating to a document submission for at least one organization;
parse the data input by natural language processing;
transmit a sequence of one or more data requests for a further data input to the user interface, the sequence of one or more data requests being determined by the large language model applying a decision tree model to the parsed data;
identify and retrieve at least one template from a template library stored in the at least one database, the at least one template being identified from a signal activated by the at least one activation element; and
merge the parsed data into the at least one template, the merge comprising:
receiving the parsed data as a first aspect of a prompt for the large language model;
receiving, from the at least one database, at least one parameter as a second aspect of a prompt for the large language model;
generating at least one response to the prompt by the large language model; and
generating an electronic document with the at least one response.

2. The system of claim 1, further comprising a conversational AI interface supported by the at least one large language model and trained using the user input, historical data, and feedback.

3. The system of claim 1, the at least one parameter being determined from compliance data, the compliance data being stored in the at least one database and identified by the signal activated by the at least one activation element.

4. The system of claim 3, further comprising an alert notification module for issuing real time alerts indicating noncompliance with one or more compliance standards associated with the at least one parameter.

5. The system of claim 1, the processor further configured to perform data validation and error checking of the initial data input and the further data inputs for errors, omissions, and consistency.

6. The system of claim 1, further comprising at least one plugin for integration with a third-party platform.

7. The system of claim 1, the processor further configured to generate one or more educational components in the user interface, the one or more educational components having learning pathways that are personalized for the user based at least on the initial data input and the further data inputs.

8. The system of claim 1, further comprising one or more accessibility features, the one or more accessibility features comprising any one of: alternative text, eye tracking, keyboard navigation support, voice command input, and screen reading.

9. The system of claim 1, further comprising one or more input access points connected by a networked, multiple user platform.

10. A method for preparing one or more documents for a networked submission using artificial intelligence, executable by at least one processor communicatively coupled to at least one database, at least one large language model, and a memory storing instructions which, when executed, cause the processor to execute the steps of the method, the method comprising:
receiving, by a user interface having at least one activation element, an initial data input from a user during a user session, the initial data input relating to a document submission for at least one organization;
parsing the data input by natural language processing;
transmitting a sequence of one or more data requests for a further data input to the user interface, the sequence of one or more data requests being determined by the large language model applying a decision tree model to the parsed data;
identifying and retrieving at least one template from a template library stored in the at least one database, the at least one template being identified from a signal activated by the at least one activation element; and
merging the parsed data into the at least one template, the merging comprising:
receiving the parsed data as a first aspect of a prompt for the large language model;
receiving, from the at least one database, at least one parameter as a second aspect of a prompt for the large language model;
generating at least one response to the prompt by the large language model; and
generating an electronic document with the at least one response.

11. The method of claim 10, further comprising supporting a conversational AI interface by the at least one large language model, the conversational AI interface being trained using the user input, historical data, and feedback.

12. The method of claim 10, the at least one parameter being determined from compliance data, the compliance data being stored in the at least one database and identified by the signal activated by the at least one activation element.

13. The method of claim 12, further comprising issuing real time alerts by an alert notification module, the real time alerts indicating noncompliance with one or more compliance standards associated with the at least one parameter.

14. The method of claim 10, further comprising data validation and error checking of the initial data input and the further data inputs for errors, omissions, and consistency.

15. The method of claim 10, further comprising utilizing at least one plugin for integration with a third-party platform.

16. The method of claim 10, further comprising generating one or more educational components in the user interface, the one or more educational components having learning pathways that are personalized for the user based at least on the initial data input and the further data inputs.

17. The method of claim 10, the user interface further comprising one or more accessibility features, the one or more accessibility features comprising any one of: alternative text, eye tracking, keyboard navigation support, voice command input, and screen reading.

18. The method of claim 10, further comprising supporting one or more input access points connected by a networked, multiple user platform.

19. A non-transitory computer-readable storage medium having embodied thereon instructions which, when executed by a processor, perform the steps of a method, the method comprising:
receiving, by a user interface having at least one activation element, an initial data input from a user during a user session, the initial data input relating to a document submission for at least one organization;
parsing the data input by at least one large language model using natural language processing;
transmitting, by the at least one large language model, a sequence of one or more data requests for a further data input to the user interface, the sequence of one or more data requests being determined by the at least one large language model applying a decision tree model to the parsed data;
identifying and retrieving at least one template from a template library stored in at least one database, the at least one template being identified from a signal activated by the at least one activation element; and
merging the parsed data into the at least one template, the merging comprising:
receiving the parsed data as a first aspect of a prompt for the large language model;
receiving, from the at least one database, at least one parameter as a second aspect of a prompt for the large language model;
generating at least one response to the prompt by the large language model; and
generating an electronic document with the at least one response.

20. The non-transitory computer-readable storage medium of claim 19, the at least one parameter being determined from compliance data, the compliance data being stored in the at least one database and identified by the signal activated by the at least one activation element.
